(19) United States
(12) Patent Application Publication
(10) Pub. No.: US 2007/0003366 A1
(43) Pub. Date: Jan. 4, 2007

(54) Joint for panels provided with a seal preventing penetration of water

(76) Inventor: Dan Wedberg, Gavle (SE)

Correspondence Address: DRINKER BIDDLE & REATH (DC), 1500 K STREET, N.W., SUITE 1100, WASHINGTON, DC, 20005-1209, US

(21) Appl. No.: 10/547,800

(22) PCT Filed: Mar. 2, 2005
(86) PCT No.: PCT/SE04/00297

§ 371 Date: Jun. 30, 2006

(30) Foreign Application Priority Data
Mar. 11, 2003 (SE) 0300642-6

(51) Int. Cl. B25G 3/00

(52) U.S. Cl. 403/410

(57) ABSTRACT

A shank adapter for rock drilling machines includes an elongate generally cylindrical body including first and second end portions, the first end portion having a thread for connecting the adapter to a drill string, the second end portion including a torque transfer structure for transferring torque between the adapter and the drill string. The body includes an internal longitudinally extending flushing channel terminating in an exit orifice disposed in the first end portion, and a side-flushing hole extending laterally from an envelope surface of the body to the flushing channel. The side-flushing hole is of non-circular cross-section. A radially external bordering edge of the side-flushing hole has a convex curvature as viewed from the envelope surface outside of the hole and is generally elongated to define opposite ends which are more sharply curved than other portions of the bordering edge.

### BACKGROUND OF THE INVENTION

This invention relates to a shank adapter for rock drilling machines of the type that comprises an elongate, suitably cylindrical body which comprises a mid portion and two end portions of which a first has a thread for connection of the shank adapter with an extension sleeve of a drill string, and a second has means for transfer of torque to the shank adapter and the drill string, and inside which body an axially extending flushing channel is provided, that terminates in an exit orifice in said first end portion of the body and in which flush medium can be introduced via at least one radial side-flushing hole that can be enclosed by a flushing head.

Conventional shank adapters (see for example SE 432 460 and corresponding Canadian Patent 1,160,214) for percussive rock drilling of generally the above-captioned type comprises a formed thread in the area of the first end surface or exit end for releaseable connection of the shank adapter to a drill string, usually via an extension sleeve. At the opposite second end surface the body has an end section of solid material against which an impact piston integrated in the very drilling machine acts. In connection to this solid end section also a set of splines is provided for torsion or rotation of the shank adapter and the drill string. At previously known adapters the axial flushing channel is produced simply by drilling a hole from one end surface in an solid, mainly cylindrical metal body. The drill is then fed inwardly from said first end of the cylindrical metal body to a point situated at a suitable distance from the opposite second end of the body in order to leave a solid section of the body between the hole's bottom and the end surface against which the piston acts.

The axial flushing channel is open radially outwardly at an area between the splines and the first end surface by means of a side-flushing hole. The side-flushing hole constitutes an inlet for flush medium such as water or air. The side-flushing hole has an elongated cross-section and extends perpendicularly to the axial flushing channel.

Through GB 2212747 a shank adapter is known, the side-flushing hole of which does not extend perpendicularly to the axial flushing channel. The known shank adapters have drawbacks of premature breakages, which can be derived from geometries of the respective side-flushing hole. Objects and features of the invention

The present invention aims to eliminate above-captioned drawbacks of earlier known shank adapters and to create an improved adapter. A main object of the invention is thus to minimize the number of breakages which can be derived to geometries of the side-flushing hole. According to the invention this object is attained by a shank adapter for rock drilling machines comprising an elongate generally cylindrical body including first and second end portions. The first end portion has a thread for connecting the adapter to a drill string. The second end portion includes a torque transfer structure for transferring torque between the adapter and the drill string. The body includes an internal longitudinally extending flushing channel terminating in an exit orifice disposed in the first end portion, and a side-flushing hole extending laterally from an envelope surface of the body to the flushing channel. The side-flushing hole is of non-circular cross section. A radially external bordering edge of the side-flushing hole has a convex curvature as viewed from the envelope surface outside of the hole and is generally elongated to define opposite ends which are more sharply curved than other portions of the bordering edge.

### BRIEF DESCRIPTION OF THE DRAWINGS

The objects and advantages of the invention will become apparent from the following detailed description of a preferred embodiment thereof in connection with the accompanying drawing in which like numerals designate like elements, and in which:

FIG. 1A shows a shank adapter according to the present invention in a side view.

FIG. 1B shows a part of the shank adapter according to FIG. 1A.

FIG. 1C schematically shows a flushing hole.

FIG. 2A shows an alternative embodiment of a shank adapter according to the present invention in a side view.

FIG. 2B shows a part of the shank adapter according to FIG. 2A.

FIG. 2C shows an axial cross-section along line C-C in FIG. 2B.

FIG. 3 shows an alternative embodiment of a flushing hole in a view corresponding to FIG. 1B.

### DETAILED DESCRIPTION OF A PREFERRED EMBODIMENT

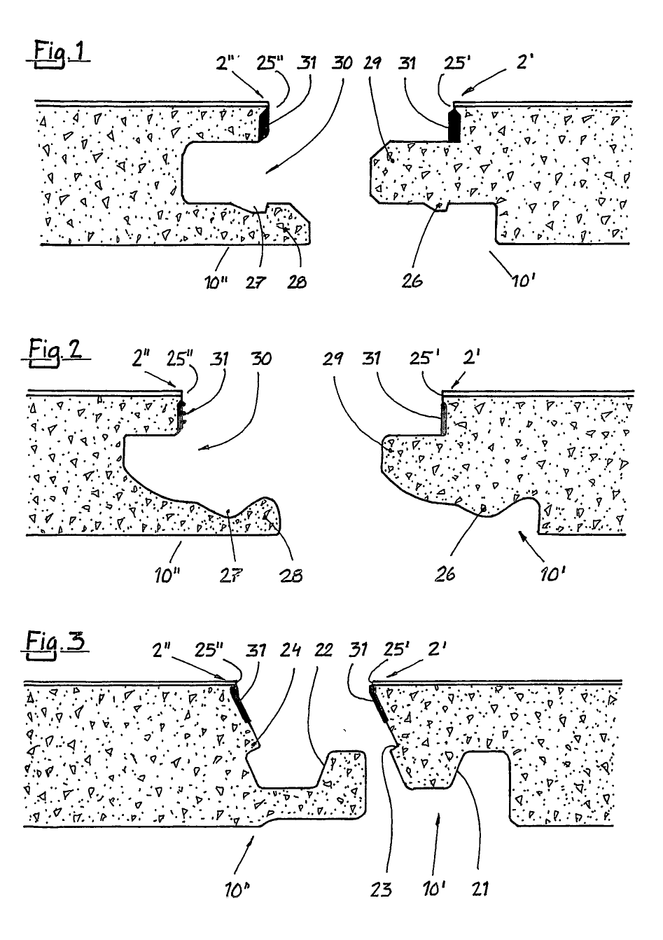

The shank adapter 10 shown in FIG. 1A comprises an elongate body 11 with a mainly cylindrical basic shape, wherein the material in the body is made of one or more metals, such as steel. The shank adapter 10 has a center line CL. An axially extending flushing channel 12 is provided internally in the body. This channel is suitably centrally localized in the body 11. Flush medium, for example water or air, can be fed into the channel via a radially directed side-flushing hole 14, which in practice is enclosed by a so called flushing head (not shown), which flush medium can be fed via a supply device (not shown). The axial flushing channel 12 is a blind hole, which terminates in an exit orifice 16 at a first end 17 of the body. A thread 18 for connection of the shank adapter with an extension sleeve to a drill string is provided in connection with this end. The thread 18 is generally a trapezoid or rope thread for percussive rock drilling. A planar end surface 20 is provided at the opposite second end surface 19 of the adapter against which the piston (not shown) of the drilling machine is intended to impact. Originating from this planar impact surface 20 a set of splines 21 is provided with the assistance of which the shank adapter can be coupled to a mechanism in the drilling machine for rotation of the shank adapter and the drill string.

FIGS. 1B and 1C show foremost the side-flushing hole 14 in the shank adapter 10 according to the present invention. The side-flushing hole 14 has a modified geometry as compared to the conventional adapters. The radially external bordering edge of the side-flushing hole 14 follows a non-circular path that is of convex curvature as viewed from the jacket surface of the body next to the hole (e.g., in direction A). Thus, the hole is elongated to define major and minor axes S, L, respectively. By the term “bordering edge” is here meant the line of intersection between the jacket surface of the body 11 and the side-flushing hole 14. The side-flushing hole 14 has been manufactured for example by an end mill, which means that the hole's axial ends 22, 23 have the smallest radius of curvature (sharpest curvature) and consequently lie on the major axis of the ellipse while the maximum points of the long sides 24, 25 consequently lie on the minor axis L of the ellipse. The major axis S of the ellipse is provided preferably parallel with the centerline of the shank adapter. The bordering edge follows a convex path at the hole's 14 mid portion, which is identical on both sides of the major axis S.

The side-flushing hole is provided generally perpendicularly directed in relation to the central flushing channel and this abrupt transition has lead to erosion-like damage on the hole's wall. Damage results from cavitation, especially at the axial end walls of the side-flushing hole where erosion corrosion arises due to inwardly directed flow.

An angled side-flushing hole in a known shank adapter has sharp corners wherein an extra deep carburized zone arises. Due to the carburizing layer being hard and brittle often damages occur there. These damages influence in turn as initiation points for fatigue cracks that spreads axially to finally give rise to breakage. Since these breakages happen inside the drilling machine they can cause expensive machine damages and in order to avoid this in places where this problem occurs one usually remove the adapters before these are worn-out.

At percussive rock drilling a shock wave is generated that propagates via adapter and other participating components before it finally reaches the rock. In order to obtain an efficient drilling it is desirable to establish a good interaction between drill bit and rock, which occurs by means of a feed force, and by rotating the drill bit to a new position before the next shock wave propagates. Shock waves, feed force and torque continuously must be adapted to the current conditions since the rigidity of the rock usually varies, which results in a varying state of strain in the participating components.

A tension analysis of the area around the flushing hole has been effected with the aid of FEM, Finite Element Method. The background is that in the prior art design cracks have been initiated and grown, substantially in two directions, which later on resulted in a breakage that caused standstill. The Finite Element analysis aimed at investigating possibilities to lower the level of tension in the area around the flushing hole via an alternative design of the flushing hole and thereby contribute to an increased life. The point of departure for analysis has been to compare the level of tension for the flushing hole in a known shank adapter according to SE 432 460 and a flushing hole in a shank adapter according to the present invention. It has shown possible to lower the level of the tension peaks around the hole periphery with up to 52% and thereby to contribute to an increased life for a shank adapter.

The ellipse shown in FIGS. 1B and 1C substantially follows the formula
X²/a²+y²/b ²=1
where 2a is length of the major axis S, and 2b is the length of the minor axis L, while x and y are coordinates of an origin centrally positioned in the ellipse. Each end 22, 23 may possibly be curved with a radius R such as shown in FIG. 1B.

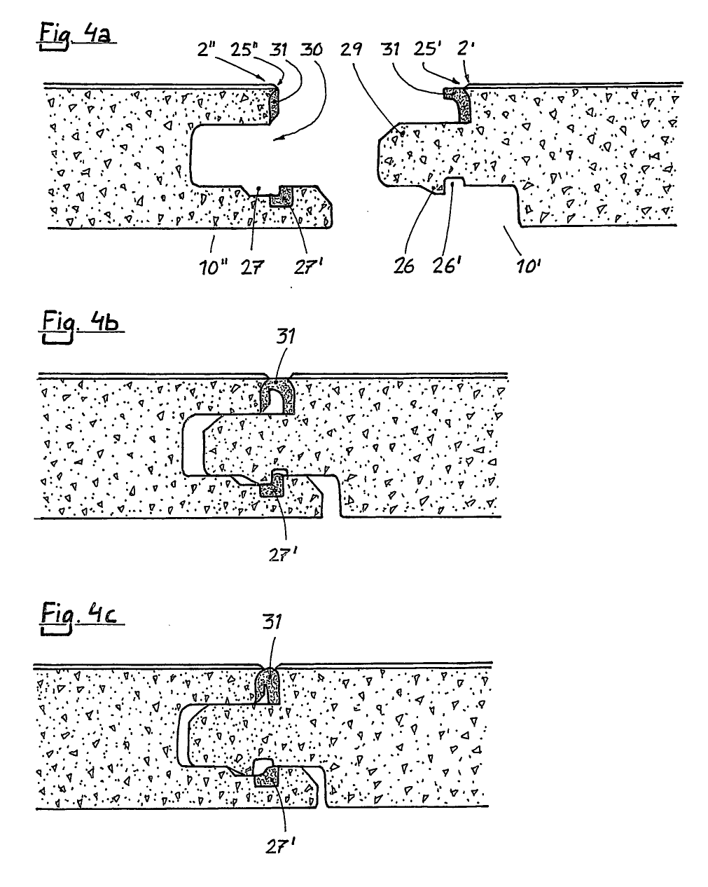

The alternative embodiment of a shank adapter 10′ according to the present invention shown in FIGS. 2A, 2B and 2C comprises the same parts as the above-described shank adapter except for differences relating to the side-flushing hole 14′. The radially external bordering edge of the hole 14′ comprises of two projected ellipses 34′, 44′ that for example have been milled with an end mill in a 30° angle relative to a normal N to the center line CL, i.e., each elliptical hole section being oriented at an oblique angle relative to the center line. The two projected ellipses overlap each other. The hole's 14′ axial ends 22′, 23′ are defined by some radius in the interval of 2-5 mm.

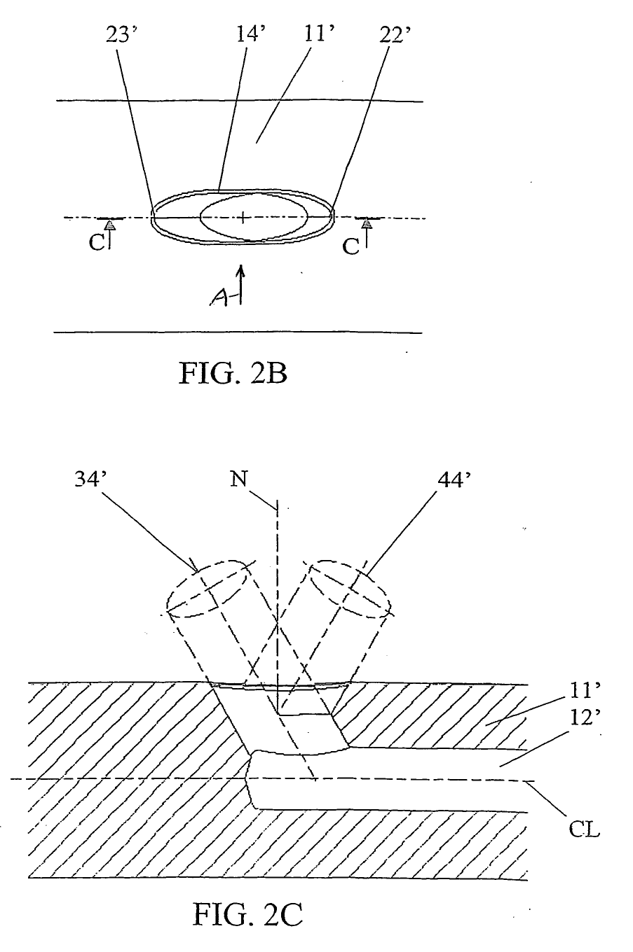

By chamfering a radially external portion 114 of the side-flushing hole such as depicted in FIG. 3 critical sharp transitions are further avoided. The hole is chamfered with for example the same end mill that was used in order to manufacture the hole. This means that the end mill during machining is moved axially as well as being angled relative to a normal to the center line CL of the shank adapter.

In all embodiments each end 22, 23, 22′, 23′ of the hole 14; 14′ is more curved than other parts of the bordering edge. That is, the ends are more curved than the mid portion of the hole. Said ends do not have to be identical.

The invention is not limited to what has been described and to the design shown in the drawings. Thus, it is conceivable to assemble the shank adapter of more than two constituents preferably of different materials, for example by friction welding.

1-7. (canceled)

8. A shank adapter for rock drilling machines comprising an elongate generally cylindrical body including first and second end portions, the first end portion having a thread for connecting the adapter to a drill string, the second end portion including a torque transfer structure for transferring torque between the adapter and the drill string, the body including an internal longitudinally extending flushing channel terminating in an exit orifice disposed in the first end portion, and a side-flushing hole extending laterally from an envelope surface of the body to the flushing channel, wherein the side-flushing hole is of non-circular cross-section, a radially external bordering edge of the side-flushing hole having a convex curvature as viewed from the envelope surface outside of the hole and being generally elongated to define opposite ends which are more sharply curved than other portions of the bordering edge.

9. The shank adapter according to claim 8 wherein the bordering edge is of substantially elliptical shape.

10. The shank adapter according to claim 9 wherein the elliptical shape has a major axis intersecting the ends of the bordering edge, and a minor axis extending perpendicular to the major axis, the bordering edge being shaped symmetrically about each of the major and minor axes.

11. The shank adapter according to claim 9 wherein each of the ends of the bordering edge is radiused.

12. The shank adapter according to claim 11 wherein each of the radiused ends has a radius in the range of 2-5 mm.

13. The shank adapter according to claim 8 wherein each of the ends of the bordering edge is radiused.

14. The shank adapter according to claim 13 wherein each of the radiused ends has a radius in the range of 2-5 mm.

15. The shank adapter according to claim 8 wherein the side-flushing hole is defined by two overlapping elliptically-shaped hole sections.

16. The shank adapter according to claim 15 wherein each hole portion extends at an oblique angle relative to a longitudinal center line of the body.
